(19) United States
(12) Patent Application Publication
(10) Pub. No.: US 2010/0230919 A1
(43) Pub. Date: Sep. 16, 2010

(54) MOBILE UNIT

(75) Inventor: Norihiko Kawada, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/723,985

(22) Filed: Mar. 15, 2010

(30) Foreign Application Priority Data
Mar. 16, 2009 (JP) 2009-062859

(51) Int. Cl. B62C 1/02; G01S 3/80; G01C 3/08

(52) U.S. Cl. 280/63; 367/118; 356/4.01

(57) ABSTRACT

A mobile unit that moves with a passenger seated thereon includes: an arm rest on which an arm of the passenger is to be placed; and a forward detection sensor that is installed at a distal end portion of the arm rest.

### INCORPORATION BY REFERENCE

The disclosure of Japanese Patent Application No. 2009-062859 filed on Mar. 16, 2009 including the specification, drawings and abstract is incorporated herein by reference in its entirety.

### BACKGROUND OF THE INVENTION

1. Field of the Invention

The present invention relates to a mobile unit, and in particular to the position of attachment of a forward detection sensor to a mobile unit.

2. Description of the Related Art

Japanese Patent Application Publication No. 2007-203965 (JP-A-2007-203965), for example, describes a coaxial two-wheel vehicle that is controlled by a passenger seated on the vehicle, through the operation of an operation-lever and a brake lever. The running control for the coaxial two-wheel vehicle is performed by setting target values for the rotational angle and the rotational angular speed for left and right driving wheels so as to achieve the set target values. In the coaxial two-wheel vehicle described in JP-A-2007-203965, the target values are set not only based on the operation states of operation modules such as an operation-lever and a brake lever but also based on object detected by an object detection sensor. In the coaxial two-wheel vehicle according to JP-A-2007-203965, the obstruction detection sensor is provided in front of a housing that is positioned below a passenger's seat.

In the case where an obstruction detection sensor is provided in front of a housing as in the coaxial two-wheel vehicle described in JP-A-2007-203965, however, the sensing area (detection area) of the object detection sensor may be blocked by the passenger's legs. It is conceivable to dispose the object detection sensor at a position where no portion of the passenger blocks the sensing area. For example, the sensor may be disposed at a position so far forward using a stay or the like that the sensing area is not blocked by a portion of the passenger. In the case where an object detection sensor is disposed at such a position, however, the object detection sensor may project too far forward of the main body of the vehicle and thereby contact objects or persons around the vehicle while the vehicle is in motion, which may be hazardous. The object detection sensor may also obstruct the passenger's action to get on and off the coaxial two-wheel vehicle.

### SUMMARY OF THE INVENTION

The present invention provides a mobile unit that provides a wide forward detection area and an enhanced safety and that is easy to get on and off.

A first aspect of the present invention provides a mobile unit that moves with a passenger seated thereon, including: an arm rest on which an arm of the passenger is to be placed; and a forward detection sensor that is installed at a distal end portion of the arm rest.

A second aspect of the present invention provides a mobile unit that moves with a passenger seated thereon, including: a forward detection sensor, in which the forward detection sensor is provided at a position at which a body of the passenger that is seated on the mobile unit does not obstruct a detection range of the forward detection sensor.

According to the present invention, a mobile body that provides a wide forward detection area and an enhanced safety and that is easy to get on and off can be provided.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a perspective view that shows the configuration of a mobile unit according to an embodiment of the present invention;

FIG. 2 is a side view that shows the configuration of the mobile unit according to the embodiment of the present invention;

FIG. 3 is a top view that shows the configuration of the mobile unit according to the embodiment of the present invention;

FIG. 4 is a perspective view that shows a state in which the mobile unit according to the embodiment of the present invention is occupied by an operator; and

FIG. 5 is a block diagram that shows the configuration of a control system for the mobile unit according to the embodiment of the present invention.

### DETAILED DESCRIPTION OF EMBODIMENTS

A mobile unit according to an embodiment is a wheeled inverted pendulum type mobile unit that moves under inverted pendulum control. The mobile unit moves to a specified position by driving its wheels which contact the ground surface. The mobile unit maintains an upright position by driving the wheels in accordance with an output from a gyro sensor or the like. The mobile unit moves in accordance with the amount of operation performed by a passenger while maintaining an upright position.

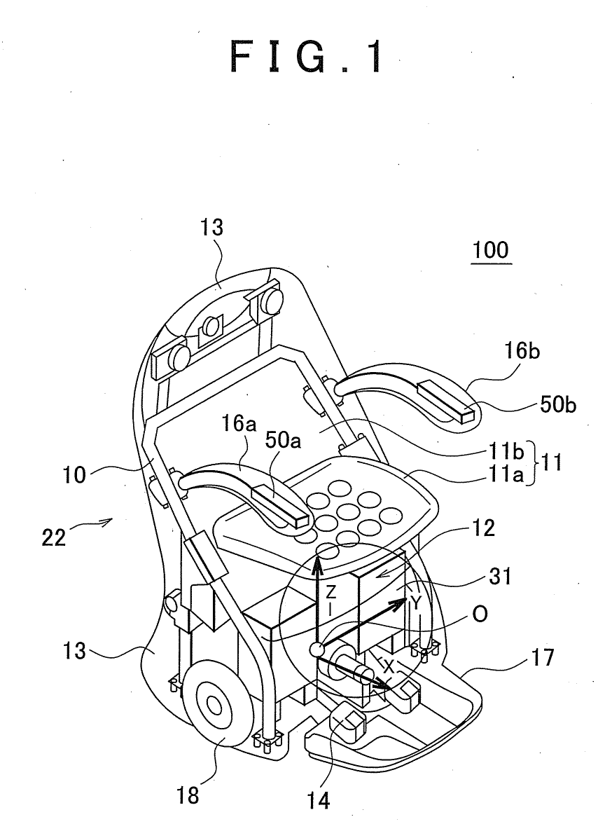

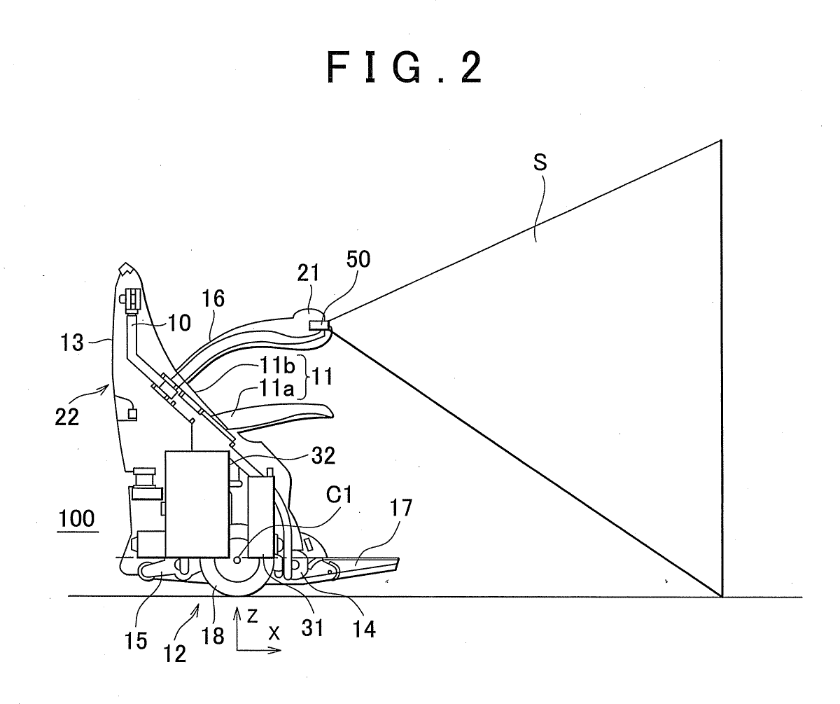

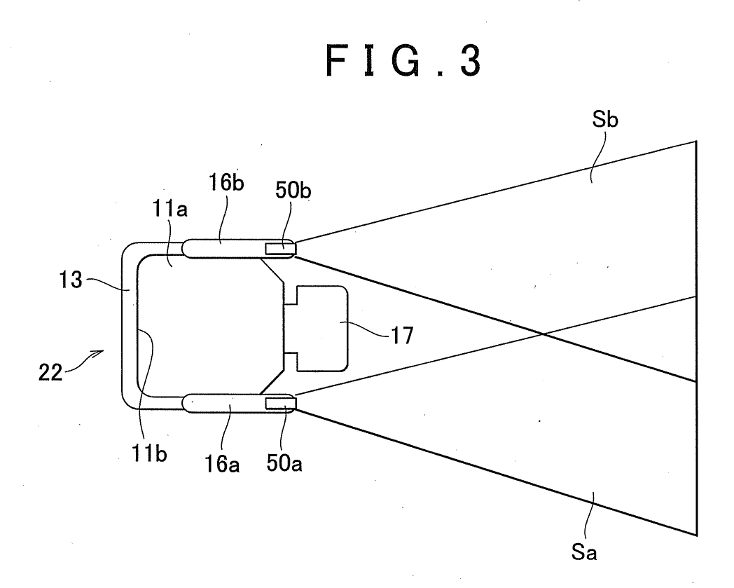

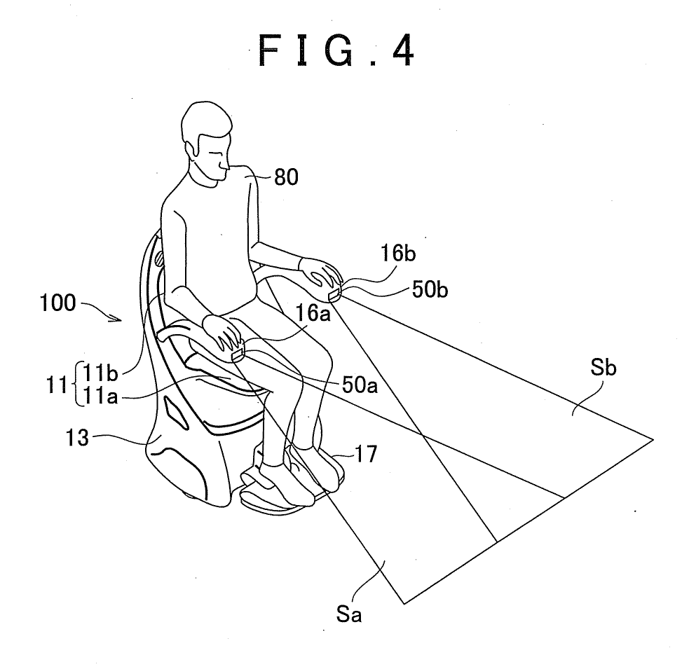

The configuration of a mobile unit 100 according to the embodiment will be described with reference to FIGS. 1 to 4. FIG. 1 is a perspective view that schematically shows the configuration of the mobile unit 100. FIG. 2 is a side view that schematically shows the configuration of the mobile unit 100. FIG. 3 is a top view that schematically shows the configuration of the mobile unit 100. FIG. 4 shows a state in which a passenger gets on board the mobile unit 100. As shown in FIGS. 1 and 2, the forward direction of the mobile unit 100 is denoted as +X-direction, the leftward direction is denoted as +Y-direction, and the upward direction is denoted as +Z-direction. In FIGS. 1 and 2, some components are shown as transparent for clear illustration.

The mobile unit 100 is a wheeled inverted pendulum type mobile unit (running unit). As shown in FIG. 2, the mobile unit 100 includes a right driving wheel 18 and a left driving wheel that are disposed coaxially with each other. In the embodiment, the rotational shaft of the right driving wheel 18 and the left driving wheel (not shown) is defined as an axle C1. The mobile unit 100 includes a passenger's seat 11 on which a passenger is to be seated. Thus, the mobile unit 100 is a seat-type mobility robot that is movable when occupied by a person. The mobile unit 100 is also movable when unoccupied. For example, the mobile unit 100 may be remotely controlled to move to the location of a user who desires to get on board when he/she controls it remotely. In another example, the mobile unit 100 may be configured to move near a user when he/she pushes a call button. After the mobile unit 100 moves to the front of the user, the user may get on board.

The mobile unit 100 is provided with a frame 10 as its skeletal structure. The frame 10 is formed from lightweight material such as aluminum pipes. The mobile unit 100 is further provided with a cover 13 that covers the frame 10. The cover 13 covers a chassis 12 to be discussed later and other devices. The mobile unit 100 is provided with a passenger's seat 11 in the shape of a chair. The passenger's seat 11 is fixed to the cover 13 and/or the frame 10. In addition, the frame 10 and the cover 13 are to conform to the shape of the passenger's seat 11.

The passenger's seat 11 includes a seat cushion 11a and a seat back 11b. The seat cushion 11a is disposed generally horizontally in order to serve as a seat surface on which a passenger 80 may site. When the passenger 80 is seated on the seat cushion 11a, the mobile unit 100 can move with the passenger 80 on board as shown in FIG. 4. The seat back 11b is formed to extend obliquely upwardly and rearwardly from the side of the seat cushion 11a in order to serve as a backrest that supports the back of the passenger 80. The mobile unit 100 moves with the passenger 80 resting against the seat back 11b.

The chassis 12 is disposed directly below the passenger's seat 11. The right driving wheel 18 and the left driving wheel are attached to the chassis 12. The chassis 12 rotatably supports the right driving wheel 18 and the left driving wheel. The right driving wheel 18 and the left driving wheel serve as wheels (driving wheels) that allow the mobile unit 100 to travel. The right driving wheel 18 and the left driving wheel rotate about the axis C1. That is, the right driving wheel 18 and the left driving wheel are disposed coaxially with each other. The chassis 12 is attached to the frame 10.

A motor (not shown) that drives the right driving wheel 18 or the left driving wheel and other devices are mounted on the chassis 12. Because the mobile unit 100 is a wheeled inverted pendulum type mobile unit, a vehicle body 22 (an upper body portion), which includes the passenger's seat 11 and other devices, is inclinable about the axis C1. That is, the vehicle body 22 which includes the passenger's seat 11 and other devices is supported rotatably. The vehicle body 22 serves as an upper body portion that rotates about the axis C1 as the center of rotation. In other words, a portion that is inclinable about the axis C1 as the center of rotation serves as the vehicle body 22. The vehicle body 22 includes the frame 10, the cover 13, and the passenger's seat 11. The vehicle body 22 may further include a part or all of the chassis 12. When the vehicle body 22 is upright, the inclination angle of the vehicle body 22 varies as the right driving wheel 18 and the left driving wheel are driven. The vehicle body 22 is provided with a gyro sensor or the like that measures the inclination angle of the vehicle body 22. As shown in FIG. 1, the midpoint between the right driving wheel 18 and the left driving wheel is defined as the center of coordinates O, which serves as the origin of the coordinate system exists on the axis C1. The travel direction of the mobile unit 100 is perpendicular to the axis C1 in a horizontal plane.

A footrest 17 is attached to the front of the chassis 12. The passenger 80 steps onto the footrest 17, and then sits on the passenger's seat 11. The footrest 17 is attached below the passenger's seat 11. The footrest 17 extends forward of the passenger's seat 11. As shown in FIG. 4, both feet of the passenger 80 are placed on the footrest 17.

A front bar 14 that prevents forward fall is provided at a middle portion of the footrest 17. Also, a rear bar 15 that prevents backward fall is provided in rear of the chassis 12. That is, the front bar 14, which is disposed forward of the axis C1, and the rear bar 15, which is disposed rearward of the axis C1, can prevent fall in the front and rear direction. The front bar 14 projects forward of the chassis 12, and the rear bar 15 projects rearward of the chassis 12. Thus, when the mobile unit 100 is inclined excessively forward, the distal end of the front bar 14 contacts the ground surface, and when the mobile unit 100 is inclined excessively rearward, the distal end of the rear bar 15 contacts the ground surface.

The front bar 14 and the rear bar 15 can be driven to rotate. The rotational axes of the front bar 14 and the rear bar 15 are set below (on the −Z side of) the axis C1 of the right driving wheel 18 and the left driving wheel. An auxiliary wheel is provided at the distal end of each of the front bar 14 and the rear bar 15. When the mobile unit 100 is upright, the front bar 14 and the rear bar 15, which each include an auxiliary wheel, do not contact the ground surface. When the passenger 80 gets on and off the mobile unit 100, the front bar 14 and the rear bar 15, which each include an auxiliary wheel, may contact the ground surface.

Arm rests 16a and 16b are provided on both sides of the passenger's seat 11. The arm rests 16a and 16b are fixed to the frame 10 and/or the cover 13. The arm rests 16a and 16b extend forward from positions slightly lower than the elbows of the passenger 80. The arm rests 16a and 16b are disposed above the seat cushion 11a. The arm rests 16a and 16b extend generally in parallel to the seat cushion 11a. The arm rest 16a is disposed on the right side of the passenger's seat 11, and the arm rest 16b is disposed on the left side of the passenger's seat 11. This allows the passenger 80 to place both his/her arms on the arm rests 16a and 16b. The arm rests 16a and 16b are attached to a middle portion of the seat back 11b. As shown in FIG. 4, both the arms of the passenger 80 are placed on the arm rests 16a and 16b when the passenger 80 is seated.

Further, the arm rest 16a is provided with an operation module 21. In the embodiment, the operation module 21 is mounted on the arm rest 16a on the right side. The operation module 21 is attached to the side of the distal end of the arm rest 16a. The operation module 21 is thus disposed reach of the right hand of the passenger 80, thereby improving the operability. The operation module 21 includes an operation-lever (not shown) and a brake lever (not shown). The operation-lever is a member operated by the passenger 80 in order to adjust the running speed and the running direction of the mobile unit 100. The passenger 80 can adjust the traveling speed of the mobile unit 100 by adjusting the operation amount of the operation-lever. Also, the passenger 80 may designate the traveling direction of the mobile unit 100 by adjusting the operation direction of the operation-lever. The mobile unit 100 may move forward, stop, move rearward, make a left turn and a right turn, and turn counterclockwise and clockwise. When the passenger 80 operates the brake lever, the mobile unit 100 comes to a stop. It is a matter of course that the operation module 21 may be mounted on the arm rest 16b on the left side, or may be mounted on both the arm rests 16a and 16b. Further, the operation module 21 may be mounted at a position other than the arm rests 16a and 16b.

In this embodiment, the arm rests 16a and 16b are respectively provided with forward detection sensors 50a and 50b. More specifically, the forward detection sensors 50a and 50b are respectively built in the distal end portions of the arm rests 16a and 16b, that is, accommodated in a space which opens forward, so that only the distal ends of the forward detection sensors 50a and 50b are respectively exposed from the front surfaces of the arm rests 16a and 16b. In the embodiment, as shown in FIG. 4, the distal ends of the forward detection sensors 50a and 50b are provided at distal end portions of the arm rests 16a and 16b at positions that is not obstructed by hands of the seated passenger 80.

Thus, an obstacle or the like may be detected over a wide range ahead without being obstructed by the passenger 80. Because there is no need to provide a special stay for the sensors, the forward detection sensors 50a and 50b do not contact an object or a person around the mobile unit 100 while it is in motion, thereby improving safety. The forward detection sensors 50a and 50b also do not obstruct the passenger's action to get on and off the coaxial two-wheel vehicle. The forward detection sensors 50a and 50b are electrically connected to a control box 32. A detection signal output from the forward detection sensors 50a and 50b is input to the control box 32.

As shown in FIGS. 2 to 4, the detection range Sa of the forward detection sensor 50a and the detection range Sb of the forward detection sensor 50b are radially wider toward the front. In particular, as shown in FIG. 4, the legs of the passenger 80 do not block the detection ranges Sa and Sb, and thus do not obstruct the detection of an obstacle or the like. The forward detection sensors 50a and 50b may each be an ultrasonic sensor or a laser range finder, which acquires information on environments in the direction of movement (ahead) of the mobile unit 100, for example.

The ultrasonic sensor includes an ultrasonic irradiation section that emits ultrasonic waves forward in a specified angular range at the same time, and a receiver section that receives reflections of the emitted ultrasonic waves. The approximate position and shape of objects present in the area irradiated with the ultrasonic waves are sensed based on the intensity of the received ultrasonic waves.

The laser range finder includes a light source that emits a laser beam forward in a specified angular range, and a receiver section that receives a reflection of the laser beam emitted from the light source. The position of an object that reflects the laser beam is detected on the basis of the irradiation angle of the laser beam and the time required for the receiver section to receive the reflection. That is, an object is sensed based on the principle of Time-of-Flight (TOF).

A battery 31 and the control box 32 are mounted on the chassis 12. The positions of the battery 31 and the control box 32 with respect to the axis C1 in the front and rear direction vary in accordance with the inclination angle of the vehicle body 22. The battery 31 and the control box 32 are placed on a base plate provided on the chassis 12. Thus, the battery 31 and the control box 32 are disposed directly below the seat cushion 11a. In this embodiment, two batteries 31 are disposed in front of the control box 32. The two batteries 31 are arranged along the Y-direction. The batteries 31 are each a rechargeable secondary battery. The control box 32 controls the charging and discharging of the batteries 31.

The control box 32 includes a Central Processing Unit (CPU), a Read Only Memory (ROM), a Random Access Memory (RAM), and an interface for communication. The control box 32 controls various operations of the mobile unit 100. The control box 32 executes various controls in accordance with control programs stored in the ROM, for example. The control box 32 controls motors and other devices through well-known feedback control such as robust control, state feedback control, and PID control to achieve a desired acceleration and a desired target speed in accordance with an operation of the operation module 21 and such that the mobile unit 100 remains upright. Consequently, the mobile unit 100 accelerates and decelerates in accordance with the operation of the operation module 21.

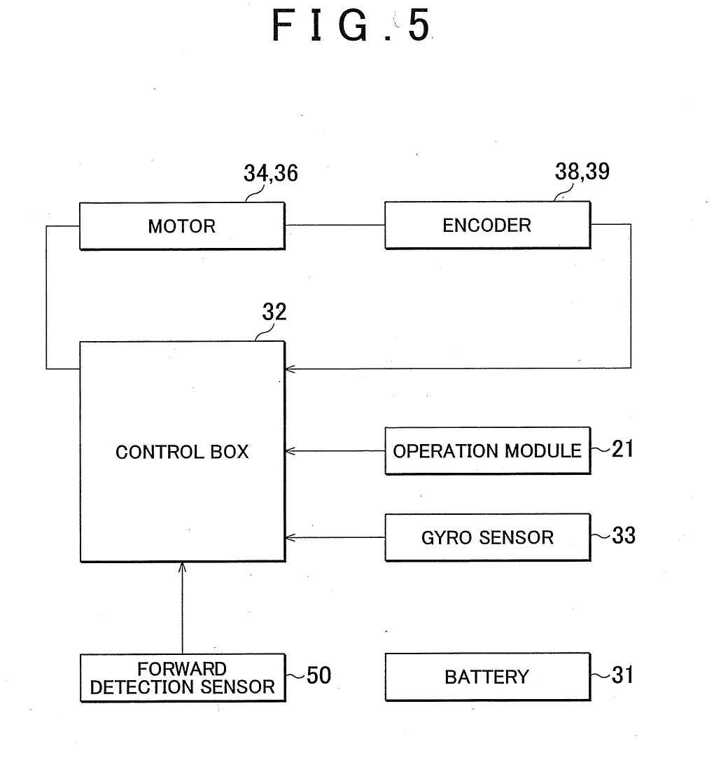

Nest, the configuration of a control system for the mobile unit 100 will be described with reference to FIG. 5. FIG. 5 is a block diagram that shows the configuration of the control system that includes the control box 32.

The control box 32 receives a signal from a gyro sensor 33 that is provided in the vehicle body 22. That is, the control box 32 receives the inclination angle that is detected by the gyro sensor 33. The gyro sensor 33 is installed in the vehicle body 22, for example. Specifically, the gyro sensor 33 is fixed to the chassis 12 near the center of coordinates O. The control box 32 also receives the operation amount from the operation module 21. For example, the control box 32 receives the translational velocity in the front and rear direction, the speed of clockwise or counterclockwise turning, and so forth as the operation amount from the operation module 21. The control box 32 receives the rotational speeds of motors 34 and 36 from encoders 38 and 39, respectively. The control box 32 further receives a detection signal from each of the forward detection sensors 50a and 50b.

Based on these inputs, the control box 32 outputs a command torque to the motors 34 and 36, which respectively drive the right driving wheel 18 and the left driving wheel. That is, the motor 34 drives the right driving wheel 18 to rotate in accordance with the command torque, and the motor 36 drives the left driving wheel to rotate in accordance with the command torque. Power from the motors 34 and 36 may be respectively transmitted to the right driving wheel 18 and the left driving wheel via a pulley or the like.

The forward detection sensors 50a and 50b detects, for example, the shape of the road surface, and obstacles ahead of the vehicle. The control box 32 detects a difference in level, obstacles, and so forth on the road surface in accordance with information on the shape of the road surface that is detected by the forward detection sensors 50a and 50b to prepare a travel path that avoids such the detected obstacles and so forth.

The control box 32 executes the inverted pendulum control based on the operation amount from the operation module 21 and the detection signal from the gyro sensor 33 to calculate control target values. The control box 32 further calculates the deviation between the control target values according to the current rotational speeds of the motors and the target rotational speeds of the motors. The control box 32 then multiplies the deviation by a predetermined feedback gain to perform feedback control. The control box 32 outputs a command value according to the driving torque to the motors 34 and 36 via, for example, an amplifier. The mobile unit 100 thus moves at the speed and in the direction according to the operation amount.

The batteries 31 supply electricity to various electric devices in the control box 32, the operation module 21, the gyro sensor 33, the motors 34 and 36, the encoders 38 and 39, and so forth. That is, all or a part of the electric devices mounted on the mobile unit 100 operate on the voltage that is supplied from the batteries 31.

Although a two-wheeled mobile unit has been described in the above example, the present invention is not restricted thereto. That is, the present invention may also be applied to a one-wheeled inverted pendulum type mobile unit or a wheeled inverted pendulum type mobile unit with three or more wheels. The present invention may further be applied to a legged walking robot.

While the invention has been described with reference to example embodiments thereof, it should be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

What is claimed is:

1. A mobile unit that moves with a passenger seated thereon, comprising:
an arm rest on which an arm of the passenger is to be placed; and
a forward detection sensor that is installed at a distal end portion of the arm rest.

2. The mobile unit according to claim 1, wherein:
the arm rest includes a first arm rest on which a right arm is to be placed and a second arm rest on which a left arm is to be placed; and
the forward detection sensor includes a first forward detection sensor that is installed at a distal end portion of the first arm rest and a second forward detection sensor that is installed at a distal end portion of the second arm rest.

3. The mobile unit according to claim 1, wherein a distal end of the forward detection sensor is provided at a distal end portion of the arm rest at a position that is not obstructed by a hand of the seated passenger.

4. The mobile unit according to claim 1, wherein the mobile unit is a coaxial two-wheel vehicle.

5. The mobile unit according to claim 1, wherein the forward detection sensor is an ultrasonic sensor.

6. The mobile unit according to claim 1, wherein the forward detection sensor is a laser range finder.

7. A mobile unit that moves with a passenger seated thereon, comprising:
a forward detection sensor,
wherein the forward detection sensor is provided at a position at which a body of the passenger seated on the mobile unit does not obstruct a detection range of the forward detection sensor.

8. The mobile unit according to claim 7, wherein the mobile unit is a coaxial two-wheel vehicle.

9. The mobile unit according to claim 7, wherein the forward detection sensor is an ultrasonic sensor.

10. The mobile unit according to claim 7, wherein the forward detection sensor is a laser range finder.
